(19) United States
(12) Patent Application Publication
(10) Pub. No.: US 2014/0029308 A1
(43) Pub. Date: Jan. 30, 2014

(54) INVERTER HAVING EXTENDED LIFETIME DC-LINK CAPACITORS

(71) Applicants: Christian Cojocaru, Ottawa (CA); Raymond Kenneth Orr, Kanata (CA)

(72) Inventors: Christian Cojocaru, Ottawa (CA); Raymond Kenneth Orr, Kanata (CA)

(73) Assignee: SOLANTRO SEMICONDUCTOR CORP., Ottawa, ON (CA)

(21) Appl. No.: 14/003,655

(22) PCT Filed: Mar. 8, 2012
(86) PCT No.: PCT/CA12/00206

§ 371 Date: Oct. 14, 2013

(51) Int. Cl. H02M 7/42

(52) U.S. Cl. CPC H02M 7/42
USPC 363/13

(57) ABSTRACT

An inverter having extended lifetime DC-link capacitors for use with a DC power source such as a photovoltaic panel is described. The inverter uses a plurality of switchable capacitors to control the voltage across the capacitors. The expected lifetime of the capacitors can be extended by disconnecting unnecessary capacitors from a voltage. The capacitors may be periodically connected to a voltage in order to maintain an oxide dielectric layer of the capacitor.

### TECHNICAL FIELD

The following description relates to an inverter for use with a direct current (DC) power source, and in particular to an inverter having extended lifetime DC-link capacitors.

### BACKGROUND

The use of photovoltaic (PV) panels, commonly referred to as solar panels, is increasing. PV panels can be used in a standalone configuration in which they provide power to connected devices, or in a grid-tied, or grid-interactive, configuration in which they supply power to an alternating current (AC) power distribution and delivery grid, or ‘grid’ for brevity. The supply of power to the grid is typically metered, and the supplier compensated financially for the amount of power supplied. As a result, there is an incentive to install PV systems in homes, buildings or other locations. In order to make a PV installation financially attractive, it is desirable to reduce the cost of the PV system, including the required installation, as well as extend the lifetime and reliability of the PV system.

FIG. 1 depicts in a block diagram a prior art grid-tied PV installation. The installation 100 comprises a plurality of PV panels 102a, 102b, 102n (referred to collectively as PV panels 102) positioned to receive sun light. The number of PV panels in a particular installation may vary greatly, from a few panels to tens of thousands of panels. The PV installation 100 is comprised of one or more parallel connected branches 106a, 106n of serially connected PV panels 102, which are in turn connected to a central inverter 110. The number of PV panels 102 in a branch 106a, 106n can be based on a maximum voltage for each branch, which may be determined based on a maximum operating voltage of the central inverter 110. The central inverter 110 is depicted as a two-stage inverter, although other inverter topologies may be used. The central inverter 110 transforms the direct current (DC) power generated by the PV panels 102 into AC power suitable for injection into the grid, depicted in FIG. 1 as a 240VAC power source 104. The central inverter 110 comprises a DC/DC converter 112 for stepping up or down the DC voltage to an appropriate level for the subsequent DC/AC inverter 114. The DC/AC inverter 114 converts the DC power into AC power which can be injected into the grid 104.

A DC-link capacitor 116 is used in order to store energy from the PV panels 102 during the cycle of the AC signal when no power is being delivered to the grid 104, or when less power is being delivered to the grid 104 than is being provided by the PV panels 102. The DC-link capacitor 116 discharges the stored energy when more power is being delivered to the grid 104 than is being delivered from the PV panels 102. As will be appreciated, the DC-link capacitor 116 repeatedly stores and discharges energy due to the sinusoidal nature of the power of the alternating current of the grid.

When a central inverter 110 is used as depicted in FIG. 1, only a single central inverter is required, and so the cost of individual components of the central inverter does not have a large impact on the overall cost of the PV installation. As such, it may be cost effective to include an expensive capacitor for the DC link capacitor 116. For example, a ceramic or film capacitor may be used. These types of capacitors, although expensive, do not degrade over time as quickly as other types of capacitors, such as electrolytic capacitors.

There is a desire to replace the central inverter 110 with individual inverters connected to each PV panel 102 in an installation. An individual inverter per panel allows the extraction of maximum electrical power from each individual PV panel, irrespective of the illumination status of other panels which might be shaded or soiled. This is not the case with a central inverter; a shaded panel will lower the electrical current for the entire series branch of which it is part. Further, with a central inverter no, there is no easy way to cut the power provided by the PV panel. This can be problematic for example, when installing the PV panels 102 since they will produce power as soon as they are exposed to light, and as such an installer may be exposed to live power wires. Similarly, in emergency situations such as a fire, if the lines connecting the PV panels to the central inverter 110 are cut, emergency personnel could be exposed to the live power lines. Additionally, trades people who install the PV panels 102 may not have experience with installing DC power components, or determining the configuration of the parallel and series connections of the PV panels 102, necessitating specialized trades people which increases the cost of the PV installation 100. By including an inverter at each PV panel 102, the installation only requires dealing with AC power components, which all electricians would be familiar with, thus possibly reducing the installation cost.

While it may be desirable to place an inverter on each PV panel 102, the cost of using expensive capacitors that do not wear out over time, or wear out relatively slowly, becomes prohibitive. Unfortunately, cost effective wet electrolytic capacitors such as aluminum electrolytic capacitors (AEC) wear out over time increasing the frequency at which the inverter, or the entire PV panel would need to be replaced, thereby increasing the cost of the PV installation.

It would be desirable to have a cost effective inverter for converting DC power to AC power, while providing an adequate lifetime without requiring the replacement of inverter components.

### SUMMARY

In accordance with the description there is provided an inverter for coupling to a direct current (DC) power source and providing an alternating current (AC) output. The inverter comprises: a DC/DC converter for connecting to DC power source and supplying a DC output; a DC/AC inverter for converting the DC output to an AC output; a DC-link energy (DCLE) storage network comprising a plurality of capacitors individually couplable across the input to the DC/AC inverter; and a DCLE storage network controller for selecting one or more of the plurality of capacitors to couple across the input to the DC/AC inverter.

In accordance with the description there is further provided a method for extending an expected lifetime of a plurality capacitors used in an inverter coupled to a direct current (DC) power source and providing an AC power output. The method comprises: determining at least one operating characteristic of the inverter; determining at least one capacitor of the plurality of capacitors to couple across an input of a DC/AC inverter of the inverter based on the determined at least one operating characteristic; and coupling the determined at least one capacitor across the input of the DC/AC inverter.

### BRIEF DESCRIPTION OF THE DRAWINGS

Various embodiments of an inverter for an individual PV panel will be described with reference to the drawings, in which:

FIG. 1 depicts in a block diagram a prior art grid-tied PV installation;

FIG. 2 depicts in a block diagram an illustrative embodiment of a grid-tied PV installation having panel inverters;

FIG. 3 depicts in a block diagram a detailed view of an embodiment of the DC-link energy storage network and controller of FIG. 2;

FIG. 4 depicts in a block diagram a detailed view of a further embodiment of the DC-link energy storage network and controller of FIG. 2;

FIG. 5 depicts in a block diagram an illustrative embodiment of components of the capacitor control functionality of FIG. 3 or FIG. 4;

FIG. 6 depicts components of an AC panel inverter;

FIG. 7 depicts AC wave forms in accordance with the AC panel inverter of FIG. 6;

FIG. 8 depicts components of a further AC panel inverter;

FIG. 9 depicts AC wave forms in accordance with the AC panel inverter of FIG. 8;

FIG. 10 depicts components of a further AC panel inverter;

FIG. 11 depicts in a flow chart an illustrative method of extending a lifetime of a plurality of capacitors;

FIG. 12 depicts in a flow chart an illustrative method that may be implemented by the capacitor selector of FIG. 5; and

FIG. 13 depicts in a flow chart a further illustrative method that may be implemented by the capacitor selector of FIG. 5.

### DETAILED DESCRIPTION

An AC inverter is described herein that can extend the lifetime of capacitors of the inverter. By extending the lifetime of the capacitors, the lifetime of the inverter may also be extended. Additionally, it may be possible to use less expensive capacitors in the inverter while still providing an adequate lifetime of the inverter. The AC inverter may be used to convert a DC power source to AC power. The DC power source may include fuel cells, wind turbines, or various energy storage devices such as batteries. The inverter is described further herein with regards to an inverter for use with a PV panel, however it may be used with other DC sources.

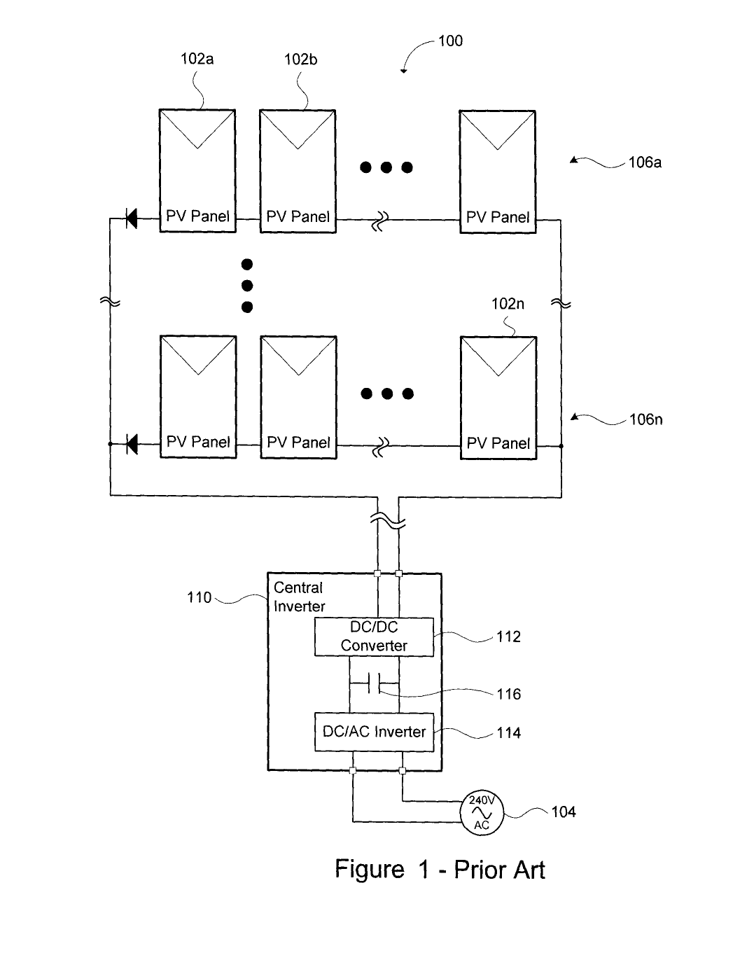

An inverter that is to be placed on an individual PV panel should be inexpensive when compared to the central inverter 110 of FIG. 1. As such, it is desirable to use the most inexpensive components possible while still providing adequate performance. However, the more inexpensive components may have a shorter expected operating lifetime. For example, due to the cost for a given capacitance times voltage (C×V) rating, it is desirable to use an electrolytic capacitor, such as an aluminum electrolytic capacitor (AEC), for the DC-link capacitor. However, electrolytic capacitors, and in particular AECs, wear out over time and eventually fail, necessitating the replacement of the capacitor, the inverter or the PV panel. Furthermore, as PV panels begin to be incorporated into building materials, such as facade material or roofing material, access to the components of the inverters becomes difficult. As such, the use of electrolytic capacitors as the DC-link capacitor, although favorable in terms of cost, may have severe drawbacks with regards to the lifetime of the inverter. It is desirable to have an inverter, including the DC-link capacitor, for a PV panel last over 25 years, which is a common lifetime for a PV panel. As described further below, a plurality of capacitors may be provided and their operation controlled in order to extend their lifetimes, thus allowing lower cost capacitors, such as electrolytic capacitors to be used, or alternatively, further extending the expected lifetime of more expensive capacitors. Although the use of electrolytic capacitors is considered in detail herein due to their favorable cost, it is contemplated that the techniques described for extending the lifetime of the capacitor could be applied to other types of capacitors that exhibit an expected lifetime that is dependent upon a voltage applied across it.

In many areas where failures are possible, it is typical to provide ‘fail-over’ or back-up components that replace a component if or when it fails. However, such an arrangement is not possible with an electrolytic capacitor that has worn out. An electrolytic capacitor uses an electrolyte as one of the plates of the capacitor. When a voltage is applied to the capacitor, the electrolyte forms an oxide layer on a strip of metal that acts as the other plate. The oxide layer acts as the dielectric for the capacitor. However, if the capacitor sits unused for long periods of time, as would be the case for a backup or fail-over capacitor, the oxide layer may dissolve back into the electrolyte. When a voltage is finally applied to the electrolytic capacitor, for example when the other capacitor fails and the backup is required, short-circuits will develop where the oxide layer has broken down and the backup capacitor will fail.

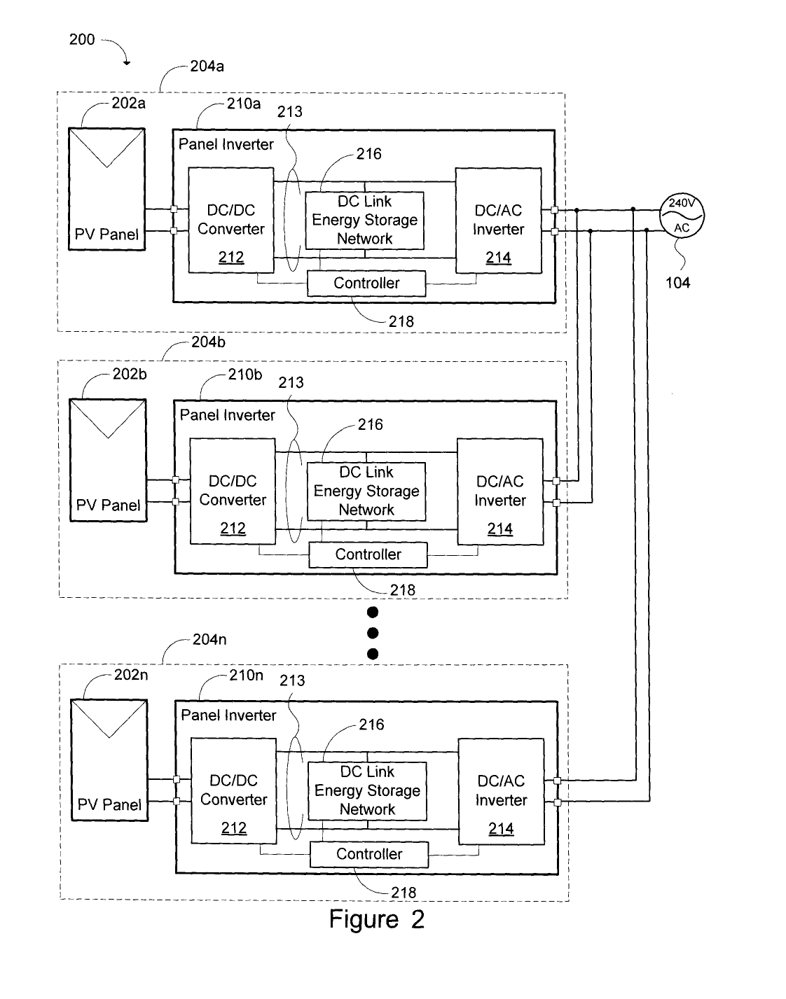

FIG. 2 depicts in a block diagram an illustrative embodiment of a grid-tied PV installation having panel inverters. The installation 200 comprises a plurality of AC panels 204a, 204b, 204n (referred to collectively as AC panels 204). Each AC panel 204a, 204b, 204n comprises a respective PV panel 202a, 202b, 202n (referred to collectively as PV panels 202) and a respective panel inverter 210a, 210b, 210n (referred to collectively as panel inverters 210). The AC panels 20₄ provide power generated by the PV panels 202 to the AC grid 104. The panel inverters 210 convert the DC power of the PV panels to AC power suitable for injection into the AC grid 104.

Each of the panel inverters 210 is depicted as a two-stage inverter, although other topologies may be used. Each of the panel inverters comprise a DC/DC converter 212 coupled to a DC/AC inverter 214 by a DC-link bus 213. A DC-link energy storage network 216 is coupled across the input to the DC/AC inverter 214.

The DC-link energy storage network 216 is comprised of two or more capacitors arranged in parallel. Each of the capacitors is selectively couplable across the input of the

DC/AC inverter 214. The DC-link energy storage network 216 replaces the DC-link capacitor of previous inverters, and provides the appropriate capacitance while being cost effective and providing an extended expected lifetime.

Each of the panel inverters 210 comprises a controller 218, which may be a micro-controller, a field programmable gate array (FPGA), an application specific integrated circuit (ASIC) or other similar device. The controller 218 controls the overall operation of the inverter 210. As described further herein, the controller 218 controls the DC-link energy storage network 216 in order to provide an appropriate capacitance in order to store and discharge energy efficiently. Additionally, the controller 218 may control the DC-link energy storage network 216 in order to extend the effective lifetime of the capacitors.

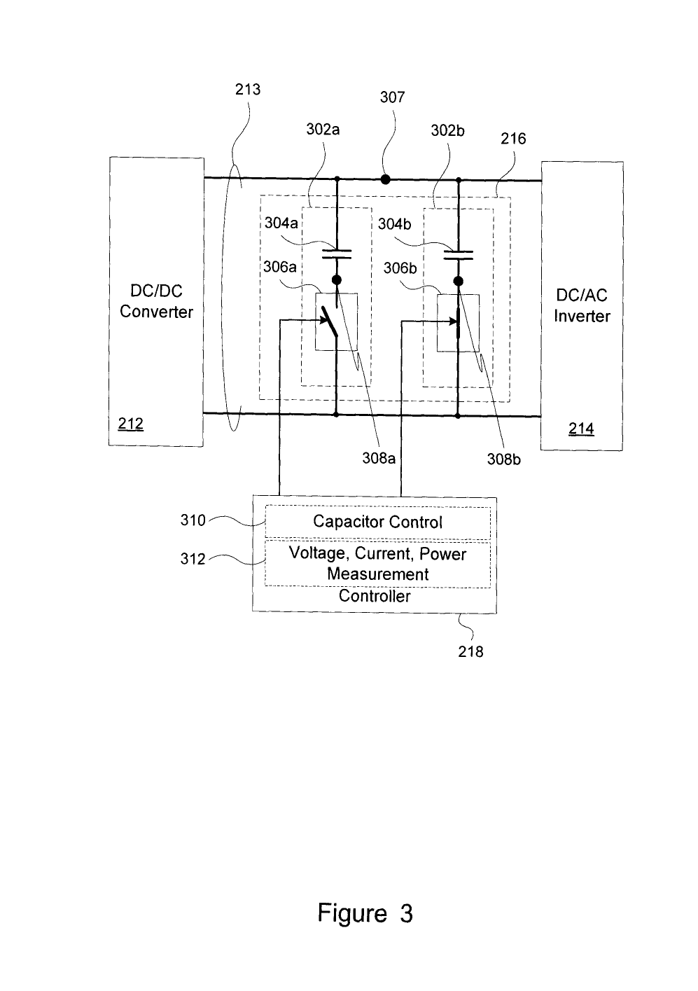

FIG. 3 depicts in a block diagram a detailed view of an embodiment of the DC-link energy storage network and controller of FIG. 2. The DC-link energy storage network 216 comprises two switchable capacitors 302a, 302b (referred to collectively as switchable capacitors 302) that can be individually coupled across the input of the DC-AC inverter under control of the controller 218. Each of the switchable capacitors 302 may comprise an electrolytic capacitor 304a, 304b connected in series with a controllable switch 306a, 306b. Although described as an electrolytic capacitor, other capacitor types may be used. The switchable capacitors 302 are controlled by the controller 218 so that, under normal conditions, one will be coupled across the input of the DC/AC inverter at a time. Capacitor control functionality 310 of the controller determines, and controls, which of the switchable capacitors 302 is connected at a particular time period. Measurement functionality 312 of the controller 218 measures a voltage, relative to a signal ground, at various points in the DC-link energy storage network 216 including measurement node 307 which measures the DC-link bus voltage, and measurement nodes 308a, 308b which measure the voltage across respective switches 306a, 306b of the switchable capacitors 302. The measured voltages may provide information to the controller 218. For example, as described further herein the voltage measured across the switch of a switchable capacitor may be used to indicate if the capacitor is at, or near, its end of life. The measurement functionality 312 may also measure the current and/or power at various locations and determine the power at various locations, including for example the power provided by the DC/DC Converter 212, which is proportional to the actual power provided by the PV panel 202

Each of the capacitors 304a, 304b is a capacitor that suffers from a wear out mechanism causing the capacitor to have an expected lifetime. The capacitors may be wet capacitors, which require a wet electrolyte for one of the plates of the capacitor, having expected lifetimes dependent upon, among other factors, voltages applied across the capacitors. Furthermore, as the capacitor ages, the provided capacitance may be reduced. For example, aluminum electrolytic capacitors (AEC) have a liquid electrolyte that acts as one plate of the capacitor. The electrolyte gradually leaks, or evaporates, out of the capacitor, and so once only a portion of the electrolyte is remaining, the capacitor will have a reduced capacitance. Further, if the electrolyte eventually completely leaks, or evaporates, out of the capacitor, the capacitor will completely fail. Additional types of capacitors may suffer from a similar wear out mechanism and could be used in the DC-link energy storage network; however, the capacitors are considered herein as being an AEC type capacitor due to their relatively low cost and C×V characteristics. For example, although other capacitors may use an electrolyte such as wet tantalum capacitors, or aerogel capacitors, they are currently either more expensive and/or do not function as well with the voltages contemplated when compared to AEC type capacitors.

The size of the capacitor, that is its capacitance, is selected based on expected operating characteristics such as a maximum generated PV power, DC voltage provided by the DC/DC converter 212, maximum desired voltage ripple on the DC link bus and a maximum ripple current through the capacitor. The DC voltage provided by the DC/DC converter may be in the range of 200-450V. Although other values are possible, a range of approximately 200-450V provides for efficient operation of the DC/DC converter 212 and the DC/AC inverter 214 as required for typical grid voltages.

Since each panel inverter is connected to a PV panel, the power delivered to the AC grid by each individual inverter is less than the power delivered by a central inverter, which provides power from a plurality of individual PV panels. This allows the use of a relatively smaller capacitor, which is advantageous since the price of capacitors of the same type is typically based on their size, rated voltage and expected lifetime. As such a higher quality of a small capacitor may be used for the same cost as a larger, lower quality capacitor. Typically, the higher the quality of the capacitor the longer its life expectancy will be.

It is desirable for the power efficiency of the panel inverter 210 to have a switch 306a, 306b that has a smaller resistance, in an ON state, than the equivalent series resistance (ESR) of the capacitor 304a, 304b. The smaller sized capacitors 304a, 304b possible with the use of panel inverters on each PV panel, have a relatively large equivalent series resistance (ESR) when compared to the ESR of a large capacitor that would be used in a central inverter, and as such provide less restrictions on the choice or design of switches. Various types of switches may be used that provide a smaller resistance in the ON state than the ESR of the capacitors 304a, 304b. The switches used must also be able to conduct current in both directions due to the cyclic nature of the AC power delivered to the AC grid. The switches 306a, 306b may be, for example, a metal-oxide-semiconductor field-effect transistor (MOSFET). Other types of switches are also possible, for example a mechanical switch such as a Reed switch that is turned on by generating a magnetic field in the vicinity of the switch.

As described above, the switchable capacitors 302 are controlled by the controller 218 so that, under normal conditions, one capacitor is coupled to the input of the DC/AC inverter at a time. The size of each of the capacitors is selected based on the maximum nominal output power from the PV panels 202 and the output voltage of the DC/DC converter 212. The capacitor control functionality 310 of the controller 218 determines which of the switchable capacitors 302 should be connected for a current time period. The capacitor control functionality 310 alternates which of the switchable capacitors 302 is connected for different time periods. The time period during which a single switchable capacitor remains connected, before switching to the other, may be for example one day. It is contemplated that other time periods, such as hours, weeks or months may be used for switching which capacitors are connected. However, if a wet electrolytic type capacitor is used in the DC-link energy storage network, the time period should be short enough to ensure that the oxide layers of the capacitors do not dissolve, which is done by periodically applying a voltage across the capacitors. The time period of one day is selected since, as described further herein, both switchable capacitors will be turned off, or disconnected from across the input to the DC/AC inverter 214, during the night time when no power is being generated by the PV panels. As such, when the day time period arrives, the switchable capacitor that will be on, or connected across the input to the DC/AC inverter 214, can be switched on prior to the PV panels generating any power. As such, no transients resulting from switching on or off a capacitor while a voltage is applied across it need to be dealt with. Although described as switching during a time when no voltage is applied across the capacitor, it is contemplated that soft switching may be employed in order to pre-charge the capacitor prior to it being switched fully on in order to allow switching of capacitors while a voltage is applied across it without creating unacceptable transients.

The life expectancy of the capacitors 304a, 304b is extended by periodically disconnecting the respective capacitors so that no voltage is applied. The lifetime of a capacitor is dependent upon, among other things, the voltage applied across it. For example, one capacitor manufacturer Cornell-Dubilier, provides the lifetime of a capacitor as:

L=L_{b}*Mᵥ*2̂(Tₘ−T_{c})/10 (1)

where:
L=Expected lifetime in hours;
L_{b}=Base lifetime in hours;
Tₘ=Maximum temperature;
T_{c}=Operating temperature; and
Mᵥ=Voltage multiplier.

The voltage multiplier Mᵥ is given by:

Mᵥ=4.3−3.3*Vₐ/Vᵣ (2)

where:
Vₐ=Applied voltage
Vᵣ=Rated voltage

As can be seen from the above equation, when the applied voltage is equal to the rated voltage, and the operating temperature is equal to the maximum temperature, the expected lifetime will be the base, or rated, lifetime. However, if the applied voltage is zero, the expected lifetime will be 4.3 times the rated lifetime. The expected lifetime equation (1) is only one model of expected capacitor lifetime. It should be understood that there exist alternative capacitor lifetime models which predict varying degrees of lifetime extensions from applied voltage reduction. As such the lifetime of the capacitor can be extended if no voltage is applied across it. However, as described above, if no voltage is applied across it for long periods of time the oxide layer can deteriorate which may cause the capacitor to fail when a voltage is next applied. In order to maintain the oxide layer of the capacitor, each switchable capacitor is periodically turned on.

It will be appreciated that the lifetime of any type of capacitor that has an expected lifetime dependent upon a voltage applied across it may be extended using the control techniques described herein. That is, although wet electrolytic capacitors may have additional beneficial factors associated with their use, such as their low cost, the lifetime of other types of capacitors may be extended by reducing an applied voltage over the operating lifetime of the capacitor.

As described above, the lifetime of the switchable capacitors can be extended by periodically disconnecting them from an applied voltage. The capacitor control functionality 310 may be used to extend further the lifetime of the DC-link energy storage network 216. Since the PV panels will only generate power when light is incident upon them, the switchable capacitors can be disconnected during the nighttime which may be determined based on an internal clock of the controller 218. Alternatively, the amount of light incident upon the PV panels may be monitored and if there is not sufficient light to produce power, the switchable capacitors may be disconnected. Alternatively still, the power generated by the PV panel may be monitored and if it falls below a threshold, the switchable capacitors may be disconnected. Depending on the specific topology of the DC/AC inverter, a voltage may be supplied to the DC link bus, and so across the switchable capacitors, even if there is no power being generated by the PV panels. As such, by disconnecting the capacitors when not required to deliver power from the PV panels to the grid, the lifetime of the capacitors may be extended by reducing the voltage applied across them.

Although the lifetime of the capacitors is extended by reducing the voltage applied across them, or the amount of time a voltage is applied across them, the capacitors will none the less still age, reducing their effective capacitance. In previous inverters, once a capacitor reached its end of life (EOL), which is generally considered to be either when its capacitance decreases to 80% of its original capacitance or when the ESR of the capacitor has increased to 200% of its original value, the capacitor or inverter had to be replaced. However, the capacitor control functionality 310 can extend the lifetime of the DC-link energy storage network 216 past the EOL of the individual switchable capacitors 304a, 304b. Once it is determined that the switchable capacitors 304a, 304b are at their EOL, the capacitor control functionality 308 will connect both switchable capacitors 304a, 304b as opposed to a single capacitor. As a result the effective capacitance of the two EOL capacitors connected in parallel may be sufficient to provide adequate performance of the DC-link energy storage network 216.

The above has described turning on both switchable capacitors 304a, 304b if both of them are at their EOL. Alternatively, if only one of the two switchable capacitors has reached its EOL, the capacitor controller 310 may favor the non-EOL switchable capacitor and connect it by itself for a majority of the time. In such a case, the capacitor controller 310 should ensure that the EOL switchable capacitor is periodically connected to a voltage, in parallel with the non-EOL capacitor in order to provide a sufficient capacitance to the DC Link Energy (DCLE) storage network in order to maintain the oxide dielectric of the EOL capacitor. Once both switchable capacitors are at their EOL, the capacitor controller 310 may always turn on both EOL capacitors in order to provide the DC-link energy storage network with sufficient capacitance. Additionally or alternatively, one of the EOL capacitors may be turned on if the required capacitance can be provided by a single EOL capacitor, for example due to reduced power output from the PV panel.

As described above, the capacitor controller 310 can control the switchable capacitors 304a, 304b to provide sufficient capacitance in the DC-link energy storage network 216 based on the conditions of the switchable capacitors, for example if they are at their EOL. The capacitor controller 3110 may further control the switchable capacitors in order to provide sufficient capacitance in the DC-link energy storage network based on the operating conditions of the inverter. For example, the capacitance of an electrolytic capacitor is a function of the temperature; the lower the temperature the lower the capacitance. As such, if the operating temperature of the inverter is below a threshold, the capacitor controller 208 may connect both switchable capacitors in order to provide sufficient capacitance in the DC-link energy storage network 216, even in cold operating environments.

FIG. 3 has described a DC-link energy storage network that uses two equally sized switchable capacitors 302. The size of the capacitors 304a, 304b is selected based on a nominal power output of the PV panel and the output voltage of the DC/DC converter 212. Although described as having only two switchable capacitors 302, additional switchable capacitors 302 may be used.

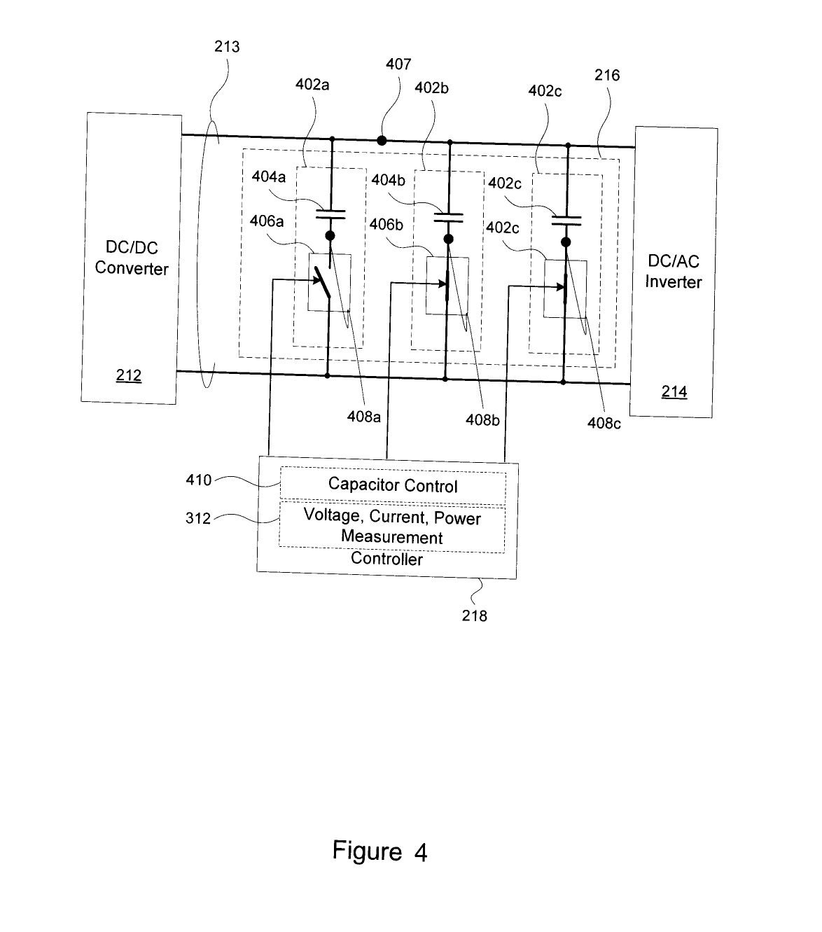

FIG. 4 depicts in a block diagram a detailed view of a further embodiment of the DC-link energy storage network and controller of FIG. 2. The DC-link energy storage network 216 of FIG. 4 is similar to the DC-link storage network 216 described above with reference to FIG. 3; however three switchable capacitors 402a, 402b, 402c are used.

As described above with reference to FIG. 3, the size of the capacitors 304a, 304b are selected based on the nominal output of the PV panel. However, the actual output of the PV panel may only provide the nominal output for a portion of the operating time. As such, the size of the capacitors 304a, 304b may be larger than required for a portion of the operating time when the PV panel output is less than the nominal output.

The DC-link energy storage network 216 of FIG. 4 uses three switchable capacitors 402a, 402b, 402c (referred to collectively as switchable capacitors 402) that are sized based on a fraction, for example ½ or ¾, of the nominal output. The capacitor control functionality 410 may determine the current power output provided by the PV panel and selects the appropriate switchable capacitors 402 to connect. For example, and assuming the capacitors are sized for 50% of the nominal output, if the PV panel is currently output 100% its nominal power, two switchable capacitors 402 will be connected. However if the output of the PV panel is less than 50% its nominal output only a single switchable capacitor 402 is connected.

The capacitor control functionality 410, similar to the capacitor control functionality 310, alternates the switchable capacitors 402 connected in order to reduce the time voltage is applied to the capacitors 404a, 404b, 404c, and so extend their lifetime. The controller 218 may include measurement functionality 312 that measures the current and voltage at various points of the DC-link energy storage network 216. The measurement functionality 312 may determine the power at various locations based on the measured current and voltage or may measure the power at various locations. The measurement functionality 312 may measure the voltages, relative to a ground signal reference, at measurement node 407, which provides the voltage of the DC-link bus 213 as well as at measurement nodes 408a, 408b, 408c which provide the voltage across respective switches of the switchable capacitors 402. The capacitor control functionality 410 also determines the appropriate number of switchable capacitors 402 to connect based on the operating conditions, for example the temperature or if any of the capacitors 404a, 404b, 404c are at their EOL.

The voltage across a switch of a switchable capacitor may be used to determine if the associated capacitor of the switchable capacitor has reached its EOL. As an electrolytic capacitor reaches its EOL, the ESR will increase. The increase in the ESR will result in a decrease in the measured voltage across the switch, since the resistance of the switch and the ESR of the capacitor effectively provide a voltage divider. As such, a measured voltage across the switch may be checked against a threshold to determine if the associated capacitor has reached its EOL.

As described above, the expected lifetime of a capacitor is affected by the voltage applied across it. The expected lifetime of a capacitor may also be affected by the ripple current through it. The larger the amplitude of the ripple current, the greater the reduction in the life expectancy. The size of the ripple current is a result of the effective size of the capacitance. The larger the capacitance, the smaller the ripple current. As such, by connecting more switchable capacitors 402 in parallel the effective capacitance is increased and the ripple current is decreased, thereby potentially extending the lifetime of the capacitor.

The above description of FIG. 4 has described a DC-link energy storage network 216 having three switchable capacitors 402. It is contemplated that more switchable capacitors may be used. The limit on the number of capacitors used in the DC-link energy storage network 216 may be determined based on the cost of adding more capacitors and switches, the additional size, and other considerations. Additionally, the switchable capacitors have been described as all having the same capacitance; it is contemplated that different sizes of switchable capacitors may be used in order to tailor the capacitance provided by the DC-link energy network based on the actual power provided by the PV panels. For example, rather than having three capacitors sized based on ½ the nominal output, three different sizes, based on for example ¼, ½ and ¾ the nominal output, could be provided.

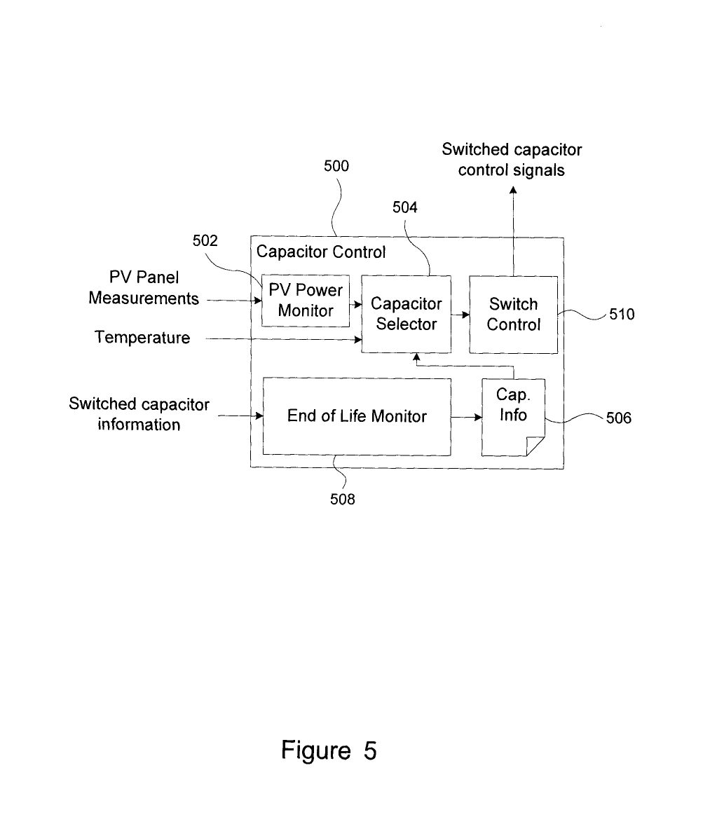

FIG. 5 depicts in a block diagram an illustrative embodiment of components of the capacitor control functionality of FIG. 3 or FIG. 4. The capacitor control functionality 500 comprises a PV power monitor 502 that monitors the power output of the PV panel. The capacitor control functionality further comprises a capacitor selector 504 that determines the switchable capacitor or capacitors to connect. The determination of which capacitor or capacitors should be connected may be made periodically, for example once an hour, once every 3 hours, once a day, once every 3 days, once a week, or once a month. The capacitor selector 504 may determine which switchable capacitors to connect based on current PV panel characteristics, such as the current power provided by the PV panel as monitored by the PV power monitor 502. The determination of which switchable capacitor(s) to connect may also be based on a measured temperature of the operating environment. Additionally, the determination of which switchable capacitor(s) to connect may also be based on capacitor information 506, for example indicating the capacitance of the different switchable capacitors, which switchable capacitors are at their EOL or which capacitors are no longer functioning and so should not be connected. The determination of which switchable capacitor(s) to connect may also be based on a length of time since the capacitor(s) were last connected or which capacitors were recently connected or disconnected, to ensure that an oxide layer remains intact.

The capacitor information 506 is depicted as being stored in a ‘file’. The ‘file’ may be a specific location in memory, such as random access memory (RAM) or non-volatile (NV) memory. However, it is contemplated that the capacitor information could be determined and provided to the capacitor selector 504 directly as required. A capacitor monitor 508 provides the capacitor information 506, either directly to the capacitor selector 504 or for storage in memory, which may be RAM or NV-memory.

The capacitor monitor 508 determines the capacitor information for each switchable capacitor. The information may be determined by measuring the characteristics of the respective capacitors. As described above, a capacitor may be determined to have reached its EOL if its ESR has increased above a threshold value. The ESR increase may be monitored by measuring the voltage across the switch of the switchable capacitor when in the ON state. When the ESR of the capacitor increases, the voltage across the associated switch will decrease. Further, it may be determined that the capacitor has reached its EOL if the ripple current, when the switchable capacitor is connected is above a threshold. Alternatively still, the capacitance may be determined and compared to see if it is below a threshold value, for example 80% of its original capacitance.

The capacitor control 500 is also depicted as having a switch control 510. If the capacitor control connects or disconnects switchable capacitors while a voltage is applied across them the switch control 510 may be employed in order to reduce the transients to an acceptable level. The switch control 510 may provide ‘soft-switching’ of the switchable capacitors by pre-charging, or discharging, the switchable capacitors before fully connecting, or disconnecting them, by modulating the switch resistance or by switching with a sequence of short pulses.

The AC panel inverters described above may extend the lifetime of capacitors of the inverter, and so potentially reduce the cost of the inverter when averaged over its lifetime. As described above, one method of extending the lifetime of the inverters is to reduce the voltage that is applied across the capacitors by disconnecting the capacitor from across the input to the DC/AC inverter. Capacitors may have a lifetime that is dependent upon the voltage applied them, and so reducing the voltage applied across them can extend the capacitor's lifetime. As described further below, the DC/AC inverter can be controlled to adjust the voltage across the DCLE network in order to control the power provided to the grid, or other load.

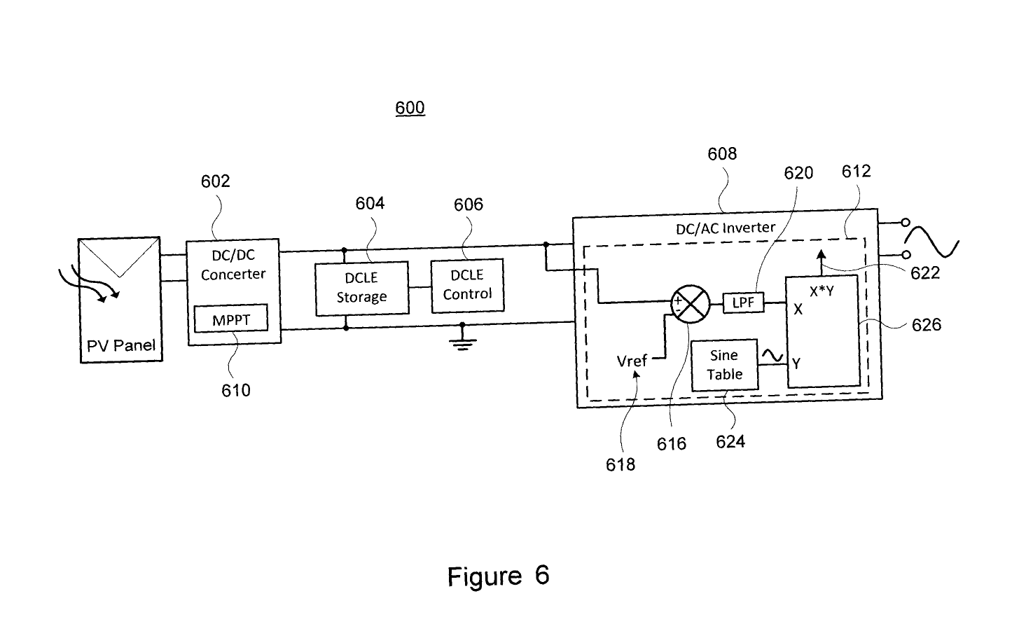

FIG. 6 depicts components of an AC panel inverter. The inverter 600 is similar to the inverters described above and may be connected to PV panel 202. The inverter 600 includes a DC/DC converter 602, a DCLE storage network 604 and controller 606 as well as a DC/AC inverter 608.

The DC/DC converter 602 may comprise a Maximum Power Point Tracker (MPPT) 610. As will be appreciated, the potential power produced by a PV panel will vary depending upon various factors including the amount of light incident upon the panel. In order to maximize the power produced by the PV panel, the MPPT may control either the voltage of the PV panel, or the current drawn from the panel by the DC/DC converter. The MPPT may be performed in various ways, including for example perturb and observer methods, incremental conductance methods, artificial neural network methods, fuzzy logic methods, etc. Regardless of the MPPT technique employed, the MPPT 610 maximizes the power provided from the PV panel. Although not included in the description of the above inverters, it is contemplated that the previously described panel inverters may employ MPPT algorithms to increase the efficiency of the PV panels.

It is desirable to have the average power provided to the grid, or other load, match the power produced by the PV panel. That is, the power supplied to the grid, averaged over one or more cycles of the AC signal, should be equal to the power produced by the panel or more particularly output by the DC/DC converter. The DC/AC inverter may be controlled in order to maintain an average voltage across the input of the DC/AC inverter 608 as close to a reference voltage as possible. The DC/AC inverter may include a controller 612 that provides a control signal 622, which may be for example a reference current, for controlling operation of the DC/AC inverter. As depicted in FIG. 6, the control signal 622 may control the operation of the DC/AC inverter such that the average voltage across the input is maintained at a particular reference voltage. The controller 612 may comprise summing functionality 616 that determines a difference between the DCLE network voltage and the reference voltage 618. As will be appreciated, the voltage across the DCLE network will vary with time due to the AC nature of the output of the inverter. As such, the controller may further include a low pass filer 620 that averages the voltage signal output by summing functionality over two or more cycles of the AC signal to produce an average difference signal. The average difference is multiplied by a time varying sinusoid 624 by multiplier 626. The resulting control signal 622 may be used as a current reference by DC/AC inverter for determining an average required voltage across the DCLE storage network. The DC/AC inverter 608 may be adjusted to maintain the average DC link as close to the reference voltage 618 as possible. The reference voltage 618 is set such that the DC link voltage will always be sufficiently high enough that the DC/AC inverter is capable of generating the required output current at the applied Root Mean Square (RMS) grid voltage level.

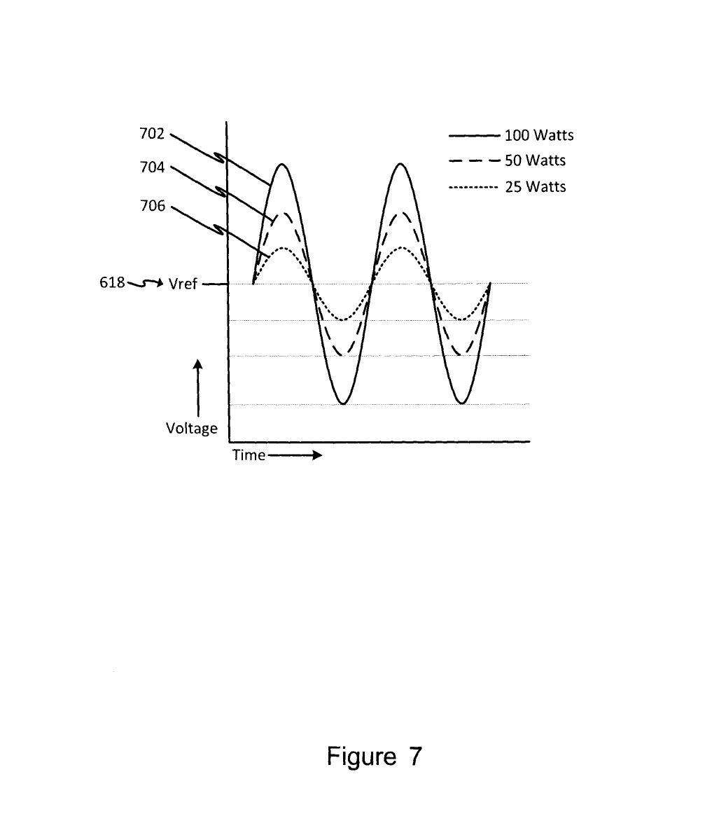

FIG. 7 depicts voltage signals in accordance with the DC/AC inverter 608 of FIG. 6. As is evident in FIG. 7, each voltage signal 702, 704, 706 is a sinusoid impressed on a DC level. The amplitude of the sinusoid varies with the PV panel power level. As depicted, the different voltage signals 702, 704, 706 have the same average voltage, which is equal to V_{ref}618, regardless of the PV panel power level. In FIG. 7, it is assumed that 100 watts is the maximum power output. As less power is produced by the panel, and so provided to the grid, the amplitude of the voltage signals change, however the average of the voltage signals is maintained as close to V_{ref}618 as possible.

While the controller 612 described above can control the inverter to provide the maximum amount of power to the AC grid, it does so by maintaining an average voltage across the DC/AC inverter input, and so the DCLE storage network regardless of the amount of power generated by the panel and drawn by the grid. The average voltage value is determined by the value of the reference voltage which is selected based on the maximum possible output power of the PV panel. However, the PV panel will not be producing the maximum possible power at all times, and as such the reference voltage may be higher than necessary when the PV panel is not producing the maximum power. As such, the controller 612 may apply a higher voltage across the DCLE storage network than necessary, thereby shortening the expected lifetime of the DCLE storage network. It is desirable to provide only the minimum necessary DC link voltage for the panel power level to further extend the lifetime of the capacitors to the extent possible, or practical.

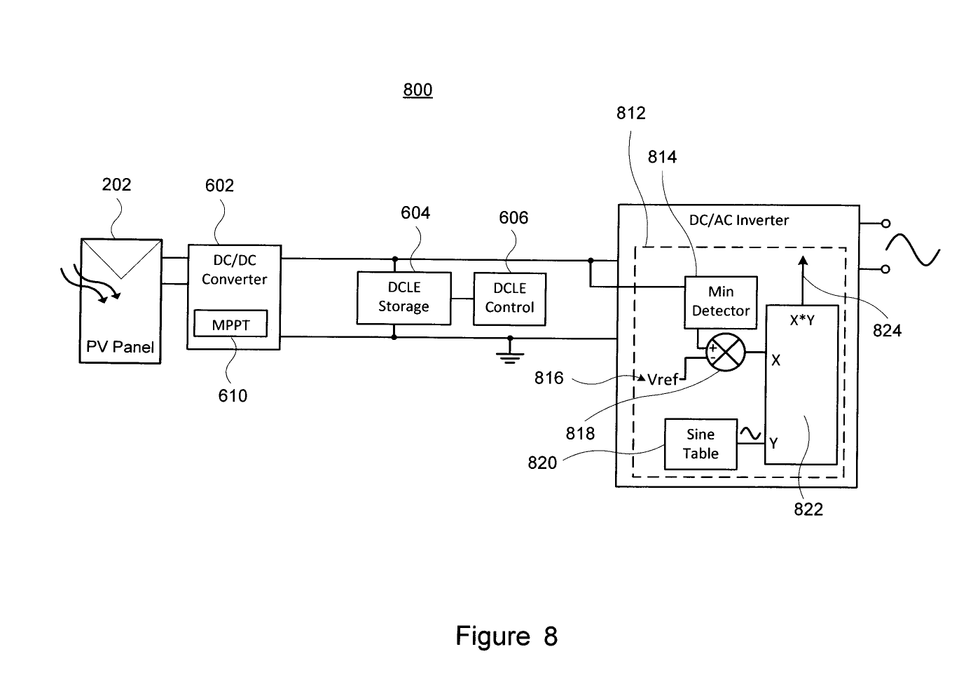

FIG. 8 depicts components of a further AC panel inverter. The AC panel inverter 800 is similar to the AC panel inverter 600 and as such, similar components are not described in further detail. In contrast to the controller 612, which adjusts a voltage across the input to the DC/AC inverter to maintain the average voltage close to a reference voltage, the AC panel inverter 800 includes a DC/AC inverter controller 812 that may control the voltage based on maintaining a minimum voltage of the voltage signal across the input to the DC/AC inverter as close to a reference voltage as possible. For power levels less than full power, the DC voltage level across the DCLE is advantageously reduced relative to the situation described with regards to FIGS. 6 and 7. As such the lifetimes of the capacitors may be further extended.

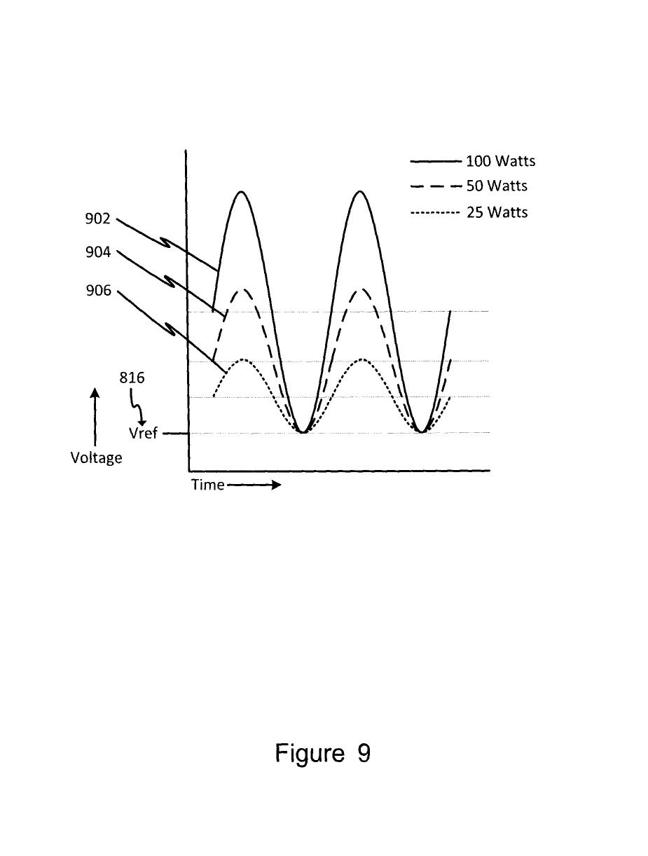

FIG. 9 is a graphical representation of the voltage across the input to the DC/AC inverter as a function of time for different panel power levels. As depicted, the minima of the sinusoids of the voltage signals 902, 904, 906 for different panel output powers are maintained as close to V_{ref}816 as possible. This is in contrast to the control described with regards to FIGS. 7 and 8 in which the average of the signals, as opposed to their minima, were controlled. As can be seen in FIG. 9, by controlling the DC/AC inverter based on the voltage signal minima, the average voltage applied across the DC/AC inverter input, and so the DCLE storage network, is reduced as the PV panel power output is reduced.

The controller 812 may includes a minima detector 814 which captures the minimum value of the voltage across the DC/AC inverter input over an AC cycle. The difference between this minimum value and reference voltage V_{ref}816 is calculated by summing functionality 818. This difference is multiplied by a time varying sinusoid 820 by multiplier 822. The resulting control signal 824 may be used as a current reference by DC/AC inverter to for determining a minimum required voltage across the DCLE storage network. The minima detector 814 captures the minimum value of the voltage across the DC/AC inverter input every two or more cycles of the DC/AC inverter input voltage ripple. Further, the minimum value received by summing functionality 818 is only updated when the output current of the DC/AC inverter is crossing through or near its zero point, in order to minimize any harmonic distortion in the output power.

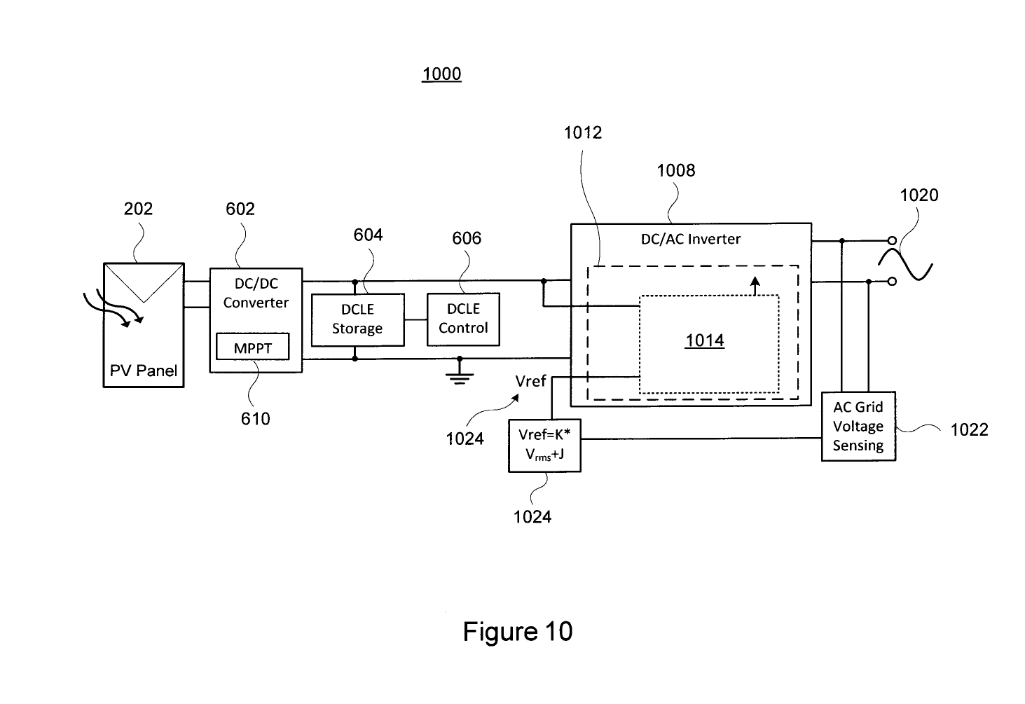

FIG. 10 depicts components of a further AC panel inverter. The AC panel inverter 1000 is similar to the AC panel inverters 600, 800 described above, and as such similar components are not described further. Both AC panel inverters 600, 800 described above control the voltage across the input to the DC/AC inverter based on a reference voltage, Vref 618, 816, although the specifics of how each controls the voltage differs. The specific control logic 1014 of the DC/AC inverter control 1012 may control the voltage based on an average of the voltage as described above with reference to FIG. 6, or may control the voltage based on detected minima as described above with reference to FIG. 8. Regardless of the particular control used, the reference voltage 1024 must be set such that the DC link voltage applied across the input to the DC/AC inverter will always be sufficiently high enough that the DC/AC inverter 1008 is capable of generating the required output current at the applied RMS grid voltage level. The grid voltage 1020 will commonly fluctuate within specified limits. For example, a commonly allowed standard fluctuation in grid voltage for North American power grids is plus or minus 15% from its nominal RMS value. In the controllers described above with reference to FIGS. 6 and 8, the reference voltage, Vref, is set to a fixed value which takes into account the maximum allowed positive excursion of the RMS grid voltage. While this ensures the DC link voltage is always sufficiently high enough that the DC/AC inverter is capable of generating the required output current in all circumstances it means that in many cases the DC link voltage is higher than it needs to be. This unnecessarily high link voltage unnecessarily reduces the lifetime of the DC link capacitor.

Rather than setting Vref to a fixed value, the reference voltage 1024 can be derived from the grid voltage as depicted in FIG. 10. A voltage sensing component 1022 measures the AC grid voltage and outputs the RMS AC grid voltage to Vref control component 1024. Vref control component 1024 sets the reference voltage value. As depicted, the reference voltage 1024 may be set based on a scaling factor, K, plus an offset value J. These values may be selected based on the characteristics of the DC/AC inverter 1012, including an efficiency of the DA/AC inverter, operating limits of the DC/AC inverter, as well as the type of voltage control employed. A change in the grid voltage from its nominal RMS value results in a corresponding change in the reference voltage which then results in a corresponding change in the DC link voltage, advantageously extending the lifetime of the DC link capacitors by reducing the voltage when the AC grid voltage decreases.

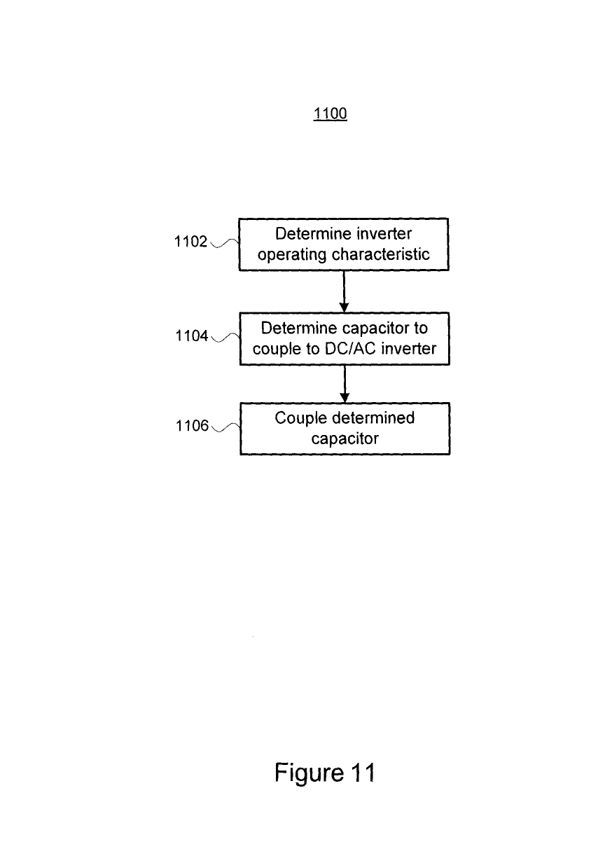

FIG. 11 depicts in a flow chart an illustrative method for extending an expected lifetime of a plurality capacitors. The capacitors may be used in an inverter coupled to a direct current (DC) power source, such as a PV panel, although other DC sources are possible. The method 1100 determines at least one operating characteristic of the inverter (1102). The operating characteristics may include for example a temperature of the inverter, a power output by the DC power source, a power output by a DC/DC converter, a determined remaining lifetime of one or more of the plurality of capacitors, a determined capacitance of one or more of the plurality of capacitors, a determined equivalent series resistance (ESR) of one or more of the plurality of capacitors, an amount of light incident upon the PV panel, an amount of time since one or more of the plurality of capacitors has been coupled across the input of the DC/AC inverter, which of the plurality of capacitors was recently coupled across the input of the DC/AC inverter, and a time of day. Once the operating characteristic or characteristics have been determined, the method determines at least one capacitor of the plurality of capacitors to couple across an input of a DC/AC inverter of the inverter based on the determined at least one operating characteristic (1104) and couples the determined capacitor or capacitors across the input of the DC/AC inverter (1106).

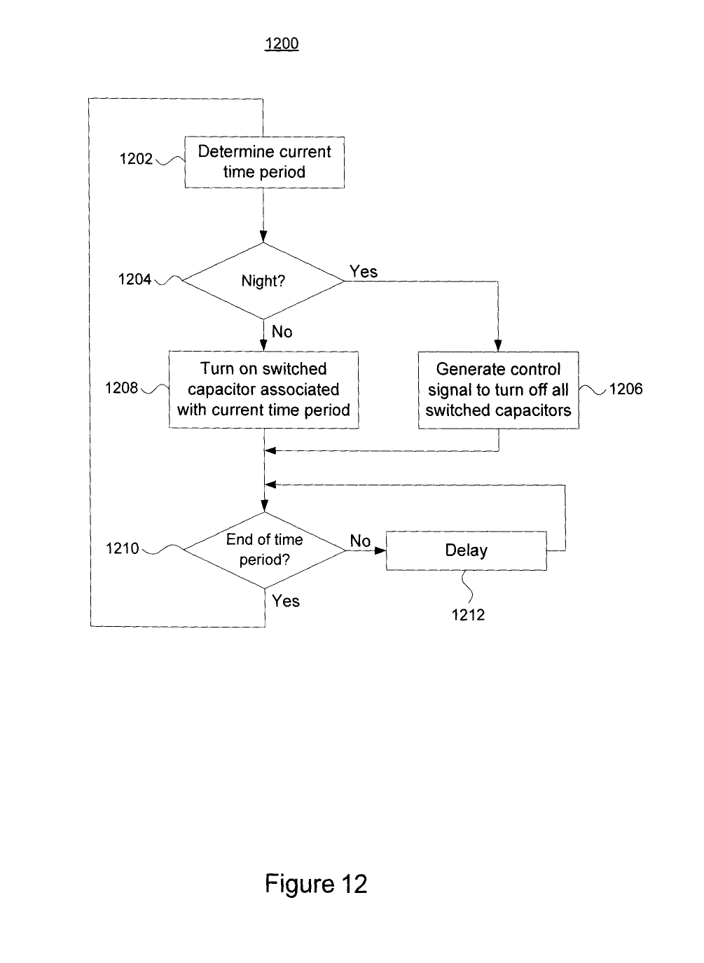

FIG. 12 depicts in a flow chart an illustrative method that may be implemented by the capacitor selector of FIG. 5. The method 1200 is depicted as a loop that is continuously performed by the capacitor selector. The method 1200 begins by determining a current time period (1202). The time period may be a day, an hour, a month or other appropriate time period. Once the time period is determined, it is determined if it is night (1204), and if it is (Yes at 1204) than appropriate control signals are generated for turning off, or disconnecting, all of the switchable capacitors (1206). If it is not night (No at 1204), than appropriate control signals are generated in order to turn on, or connect, the switchable capacitor associated with the time period (1208). Once the control signals are generated, either at 1206 or 128, it is determined if it is the end of the time period (1210). If it is not the end of the time period (No at 1210) a delay is performed (1212) before checking again to see if it is the end of the time period (1210). If it is the end of the time period (Yes at 1210) then the method returns to determine the current time period at 1202.

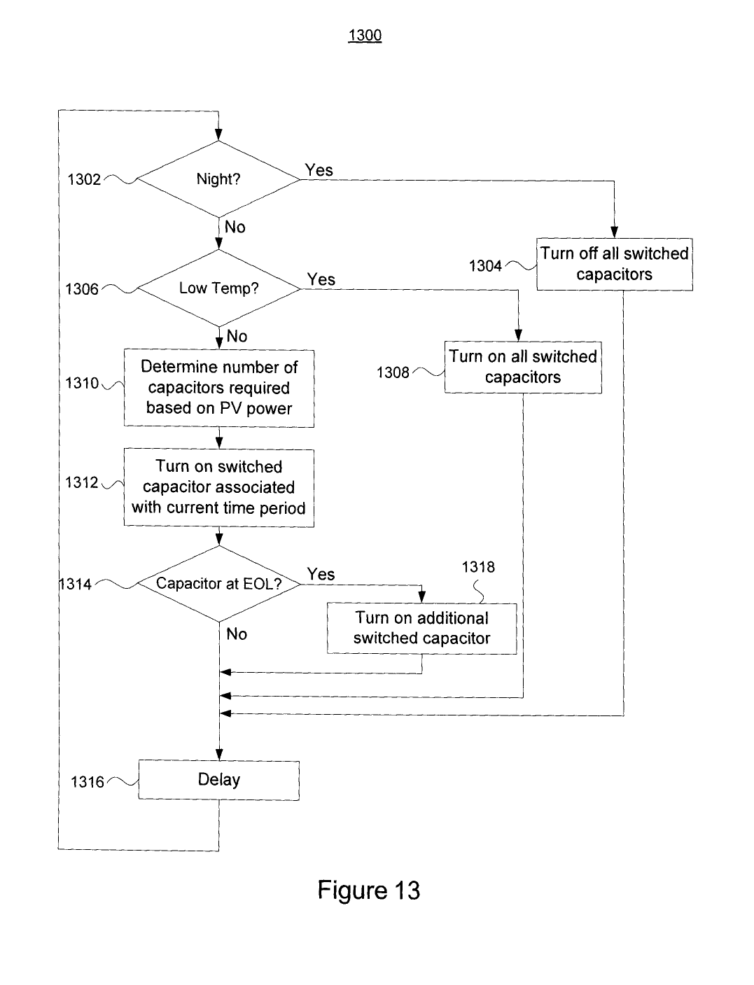

FIG. 13 depicts in a flow chart a further illustrative method that may be implemented by the capacitor selector of FIG. 5. The method 1300 begins by determining if it is night (1302), and if it is (Yes at 1302) then appropriate control signals are generated for turning off, or disconnecting, all of the switchable capacitors (1304). If it is not night (No at 1302), then it is determined if the operating temperature is below a threshold value (1306), and if it is (Yes at 1306) the appropriate control signals are generated for turning on, or connecting, all switchable capacitors (1308). Although described as turning on all switchable capacitors, it is contemplated that the method may determine the appropriate number of switchable capacitors to turn on in order to provide adequate capacitance. If the temperature is not below a threshold value (No at 1306), the method determines the number of capacitors required to turn on based on the actual power produced by the PV panel (1310). The method then turns on the appropriate number of switchable capacitors (1312). Which of the switchable capacitors to turn on may be determined based on which of the switchable capacitors have been turned off for the longest period of time, which may ensure that a voltage is periodically applied across each switchable capacitor in order to maintain the oxide layer of the switchable capacitor. The method then determines if the switchable capacitors that are turned on are past their EOL (1314). If they are not (No at 1314) then the method may delay (1316) for a period of time before returning to determine if it is night (1302). If the switchable capacitor(s) that are turned on is past its EOL (Yes at 1314), than the method turns on one or more additional switchable capacitors (1318) in order to provide sufficient capacitance based on the power produced by the PV panel. Although the determination as to whether a capacitor is past is EOL is described as occurring after turning on the switchable capacitor, it is contemplated that the determination could be made prior to turning on the switchable capacitor. Once the additional switchable capacitor(s) are turned on, the method may delay (1316) before checking again to see if it is night (1302).

Although the above discloses example methods, apparatus including, among other components, software executed on hardware, it should be noted that such methods and apparatus are merely illustrative and are intended to provide a complete understanding of extending a lifetime of capacitors in an inverter for a PV panel. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

The AC panel inverters described herein utilize low cost electrolytic capacitors, although the AC panel inverter may extend the lifetime of other types of capacitors that have a lifetime dependent upon an applied voltage. By controlling the voltages applied across the capacitors, it is possible to extend the expected lifetime of each of the individual capacitors. By extending the expected lifetime of the capacitors, more reliable performance can be provided for a longer period of time. Since the lifetime of individual capacitors is extended, it is possible to provide an inverter having greater fault tolerance, since additional capacitors that can be used in place of a failed capacitor will be available for longer periods. For example, if after 11 years of operation one of the capacitors fails in an inverter having two capacitors, the expected lifetime of the second remaining capacitor may be sufficient to provide proper operation for the desired lifetime of the inverter, such as an additional 15 years for a total lifetime of 25 years.

Additionally, the above has described a DC-link energy storage network that may extend the expected lifetime of electrolytic capacitors by periodically connecting and disconnecting them from the DC-link bus to reduce a voltage applied across the capacitor while still ensure the oxide layer does not deteriorate. As described, by periodically applying a voltage across the electrolytic capacitors the dielectric oxide layer is maintained. It is contemplated that rather than periodically turning on and off capacitors to extend their lifetime while maintaining the oxide layer, a switchable capacitor may remain off until it is required, for example due to the other switchable capacitor reaching its EOL. In order to ensure that the switchable capacitor does not fail when turned on again due to degradation of the oxide layer, the dielectric oxide layer may be re-formed by applying a voltage for a period of time sufficient to re-form the oxide layer.

Although the above has described a panel inverter for use with a PV panel, it is contemplated that the inverter, or components of the inverter, may be used with other DC power sources. The inverter described above can provide an economical inverter while still providing adequate expected lifetime by extending the lifetime of the capacitors.

1. An inverter for coupling to a direct current (DC) power source and providing an alternating current (AC) output, the inverter comprising:
a DC/DC converter for connecting to the DC power source and supplying a DC output;
a DC/AC inverter for converting the DC output to an AC output;
a DC-link energy (DCLE) storage network comprising a plurality of capacitors each individually couplable across the input to the DC/AC inverter; and
a DCLE storage network controller for selecting one or more of the plurality of capacitors to couple across the input to the DC/AC inverter.

2. The inverter of claim 1, wherein the DCLE storage network controller comprises
a capacitor selector for selecting the one or more capacitors to couple to the input to the DC/AC inverter based on at least one monitored characteristic.

3. The inverter of claim 2, wherein the at least one monitored characteristic comprises one or more of:
a temperature;
a power output by the DC power source;
a power output by the DC/DC converter;
a determined remaining lifetime of one or more of the plurality of capacitors;
a determined capacitance of one or more of the plurality of capacitors;
a determined equivalent series resistance (ESR) of one or more of the plurality of capacitors;
an amount of light incident upon the PV panel;
an amount of time since one or more of the plurality of capacitors has been coupled across the input of the DC/AC inverter;
which of the plurality of capacitors was recently coupled across the input of the DC/AC inverter; and
a time of day.

4. The inverter of claim 2, wherein the at least one monitored characteristic comprises an indication of if one or more of the plurality of capacitors has reached its end of life (EOL), the DCLE storage network controller comprises:
a capacitor monitor for determining capacitor characteristics of each of the plurality of capacitors, the capacitor characteristics including whether a capacitor has reached an end of life (EOL) where the capacitance of the capacitor is below a capacitance threshold value or where the equivalent series resistance (ESR) is above an ESR threshold value.

5. The inverter of claim 4, wherein the capacitor characteristics include whether a capacitor has failed.

6. The inverter of claim 1, further comprising
a plurality of switches, each associated with a respective one of the plurality of capacitors, for selectively coupling the associated capacitor across the input to the DC/AC inverter under control of the DCLE storage network controller.

7. (canceled)

8. The inverter of claim 1, wherein the DCLE storage network controller comprises:
a switch controller for providing soft-switching of each of the plurality of capacitors.

9. The inverter of claim 1, wherein one or more of the plurality of capacitors are electrolytic capacitors.

10. The inverter of claim 9, wherein the DCLE storage network controller couples each of the one or more electrolytic capacitors to the input of the DC/AC inverter at least once within a given time period.

11. (canceled)

12. (canceled)

13. (canceled)

14. The inverter of claim 1, wherein the DCLE storage network comprises two capacitors that are sized based on an expected power output of the DC power source.

15. (canceled)

16. (canceled)

17. The inverter of claim 1, wherein the DC power source comprises a photovoltaic (PV) panel.

18. (canceled)

19. The inverter of claim 1, further comprising:
a DC/AC inverter controller for controlling the voltage across the input of the DC/AC inverter, wherein the DC/AC inverter controller controls the voltage across the input of the DC/AC inverter based on maintaining an average of the voltage across the input of the DC/AC inverter as close to a reference voltage as possible.

20. The inverter of claim 1, further comprising:
a DC/AC inverter controller for controlling the voltage across the input of the DC/AC inverter, wherein the DC/AC inverter controller controls the voltage across the input of the DC/AC inverter based on maintaining a minima of the voltage across the input of the DC/AC inverter as close to a reference voltage as possible.

21. The inverter of claim 19, wherein the AC output is provided to an AC power grid, and wherein the reference voltage is dependent on an applied grid voltage.

22. A method for extending an expected lifetime of a plurality capacitors used in an inverter coupled to a direct current (DC) power source and providing an AC power output, the method comprising:
determining at least one operating characteristic of the inverter;
determining which capacitor of the plurality of capacitors to couple across an input of a DC/AC inverter of the inverter based on the determined at least one operating characteristic; and
coupling the determined capacitor across the input of the DC/AC inverter.

23. The method of claim 22, wherein the at least one operating characteristic comprises at least one of:
a temperature;
a power output by the DC power source;
a power output by the DC/DC converter;
a determined remaining lifetime of one or more of the plurality of capacitors;
a determined capacitance of one or more of the plurality of capacitors;
a determined equivalent series resistance (ESR) of one or more of the plurality of capacitors;
an amount of light incident upon the PV panel;
an amount of time since one or more of the plurality of capacitors has been coupled across the input of the DC/AC inverter;
which of the plurality of capacitors was recently coupled across the input of the DC/AC inverter; and
a time of day.

24. The method of claim 22, further comprising:
detecting that one of the plurality of capacitors has failed; and
coupling at least one of the plurality of capacitors that have not failed across the input of the DC/AC inverter to provide a required capacitance.

25. The method of claim 22, further comprising:
determining if one or more of the capacitors of the plurality of capacitors have reached an end of life (EOL); and
determining which capacitor to couple across the input of the DC/AC inverter based on if one or more of the capacitors has reached its EOL.

26. The method of claim 22, further comprising:
providing soft-switching of one or more capacitors of the plurality of capacitors when coupling or de-coupling the one or more capacitors to or from the input of the DC/AC inverter.

27. The method of claim 22, wherein determining which capacitor to couple across the input to the DC/AC inverter comprises determining which capacitor to couple across the input of the DC/AC inverter to ensure that each of the plurality of capacitors is coupled across the input to the DC/AC inverter within a time period.

28. (canceled)

29. (canceled)

30. (canceled)

31. The method of claim 22, further comprising:
controlling the voltage across the input of the DC/AC inverter.

32. The method of claim 22, further comprising:
controlling the voltage across the input of the DC/AC inverter, wherein controlling the voltage across the input of the DC/AC inverter is based on maintaining an average of the voltage across the input of the DC/AC inverter as close to a reference voltage as possible.

33. The method of claim 22, further comprising:
controlling the voltage across the input of the DC/AC inverter, wherein controlling the voltage across the input of the DC/AC inverter is based on maintaining a minima of the voltage across the input of the DC/AC inverter as close to a reference voltage as possible.

34. The method of claim 32, wherein the AC output is provided to an AC power grid, the method further comprising setting the reference voltage based on an applied grid voltage.

35. (canceled)

36. The method of claim 34, further comprising:
decoupling any capacitors not determined to be coupled across the input of the DC/AC inverter, wherein determining which capacitor to couple across the input of the DC/AC inverter comprises:
determining which two or more capacitors of the plurality of capacitors to couple across an input of a DC/AC inverter of the inverter based on the determined at least one operating characteristic; and
wherein coupling the determined capacitor across the input of the DC/AC inverter and decoupling any capacitors not determined to be coupled across the input of the DC/AC inverter comprises:
coupling the determined two or more capacitors across the input of the DC/AC inverter and decoupling any capacitors of the plurality of capacitors not determined to be coupled across the input of the DC/AC inverter.
